(19) United States
(12) Patent Application Publication
(10) Pub. No.: US 2016/0170076 A1
(43) Pub. Date: Jun. 16, 2016

(54) HIGH FIDELITY PORTABLE SCANNER FOR INSPECTION OF PACKAGES

(71) Applicant: SATPAL SINGH, Potomac, MD (US)

(72) Inventor: SATPAL SINGH, Potomac, MD (US)

(21) Appl. No.: 14/571,020

(22) Filed: Dec. 15, 2014

(51) Int. Cl. G01V 5/00

(52) U.S. Cl. CPC G01V 5/0066

(57) ABSTRACT

A portable radiation system is described that employs transmissive x-ray imaging for the inspection of an object positioned between a source and a detector. In one embodiment, the source is kept stationary and the detector is rotated about an axis that passes through the center of source to scan the object. This rotational scan eliminates the degradation in scanned images that would have otherwise resulted due to shaking of the detector if the source and detector were both moved over a rough terrain. Multiview scans are obtained by moving source and detector to additional locations around the object. In another embodiment, multiview scans are obtained by changing the angular position of the detector. Multview scans are then additionally combined to generate 3D information of the object.

### BACKGROUND OF THE INVENTION

A portable high fidelity scanner especially suited for inspection of suspicious packages is described.

### DESCRIPTION OF THE RELATED ART

U.S. Pat. No. 8,734,013 B2 to Singh describes a small mobile x-ray scanning system for inspection of packages left in buildings or outdoors. The system described has an x-ray generator mounted on a mobile platform and a detector suspended at a distance from the source such that the package to be inspected is situated in between the source and detector during the scanning operation. One problem encountered with such systems is that as the mobile platform drives over an uneven surface, the scanned image gets distorted due to shaking of the detector. Since the detector arm is pivoted on the mobile platform and extends outwards approximately three feet, even very small vibrations of the platform get amplified at the detector end. This situation is similar to fixing a long pole at one end while the other end is free floating. Now if small vibrational displacement is given at the fixed end of the pole, the longer the pole, greater is the displacement at the free end of the pole. Likewise, in the system described by Singh, even tiny vibrations of the platform result in substantial vibrations of the detector that lead to blurring and loss of resolution of the scanned image. Therefore, a method is desired where the loss of resolution due to vibrations can be eliminated or reduced.

Suspicious package scanning requires that the package not be moved as it might contain a motion triggered bomb. It is also desired to estimate the size of threat and the location with 3D coordinates inside the package so that counter threat measures could be taken. However, the current methods employed to scan left behind packages produce 2D images. It is therefore desired to have a method that is suitable for 3D imaging of leave behind packages.

The objects of this invention are therefore to overcome some of the above problems and are listed next.

### OBJECTS AND ADVANTAGES OF THE INVENTION

It is, accordingly, an object of the invention to develop a portable inspection system suitable for inspection of leave behind packages and capable of producing high fidelity images.

Another object of the present invention is to generate 3D images without moving the package that has been left on the floor of a building or outdoors.

There are several embodiments and advantages that will become apparent in the description that follows.

### SUMMARY OF THE INVENTION

In accordance with one embodiment, a portable scanner is presented that is especially suited for x-ray inspection of packages. An x-ray source and a detector are used to implement a transmissive x-ray imaging of an object or a package. The source is mounted on a small mobile platform close to the ground level. A vertical member rising above the source supports a linear detector array assembly at a predetermined distance from the source. This detector assembly rotates about a vertical axis that is coincident with the vertical member supporting it. To implement the scan, the mobile platform is moved to a location such that the package or object to be inspected gets positioned in between the source and detector. The mobile platform is then kept stationary and the detector arm is rotated over an arc to scan the object.

To further inspect the object from another angle or view, the mobile platform is moved a small predetermined distance and another angular or rotational scan of the detector arm implemented to generate a scanned image. Moving the mobile platform repeatedly along a straight path or to different locations around the object, multiple views of the object from different angles are generated. These multiple angle views are then combined in a computer using the methods of tomosynthesis or tomography to generate 3D information of the object.

In another embodiment, the detector assembly is held fixed at a predetermined angle while the mobile platform moves so that the object to be inspected passes in between the source and the detector. This generates a scan with a view of the object looking along the angle of incidence at which the radiation beam from the source to the detector intercepts the object. Next, the detector arm is rotated by a predetermined angle, this changes the angle of incidence at which the radiation beam intercepts the object. The angle of the detector arm is then kept fixed while the mobile platform is moved again to implement a second scan of the object from a different angle. By repeatedly rotating the detector assembly by predetermined angles, and then moving the mobile platform to scan the object, multiple angle views of the object are generated which are then combined in a computer using tomosynthesis or tomographic methods to generate 3D information of the object.

There are several embodiments, objects and advantages to this invention that will be apparent to one skilled in the art. The accompanying figures and description herein should be considered illustrative only and not limiting or restricting the scope of invention, the scope being indicated by the claims.

### BRIEF DESCRIPTION OF THE DRAWINGS

FIG. 1 shows one embodiment.

FIGS. 2A to 2D demonstrate the scanning operation in accordance with embodiment shown in FIG. 1. FIG. 2A shows the top view with the detector arm at the center position. FIG. 2B shows the rotation of the detector arm to implement the scan. FIG. 2C shows the fan beam shaped geometry traced by the detector arm. FIG. 2D shows the radiation paths within the fan beam shaped scan geometry.

FIGS. 3A to 3D demonstrate multiview scanning using the embodiment of FIG. 1. With reference to the central position of the detector arm, FIG. 3A shows object to one side of detector arm, FIG. 3B shows the object in the center and FIG. 3C shows object on the other side of the detector arm. FIG. 3D shows the superimposition of the scan geometries for the scans for FIGS. 3A to 3C.

FIGS. 4A to 4C demonstrate multiview scanning using another embodiment. With reference to the central position of the detector arm, FIG. 4A shows scans taken with detector arm positioned at a fixed angle to one side of the object, FIG. 4B shows scan taken with detector arm fixed at zero angle, and FIG. 4C shows scan taken with detector arm positioned at a fixed angle to the other side of the object.

FIGS. 5A to 5C show the respective ray paths or ray trajectories for scans of FIGS. 4A, 4B and 4C.

FIG. 5D shows the superimposition of ray paths of FIGS. 5A, 5B and 5C for the reconstruction of point A using the method of back projection.

### DETAILED DESCRIPTION OF THE PREFERRED EMBODIMENTS

In describing the first embodiment and its alternatives, specific terminology will be used for the sake of clarity. However, the invention is not limited to the specific terms so used, and it should be understood that each specific term includes all its technical equivalents which operate in a similar manner to accomplish similar purpose.

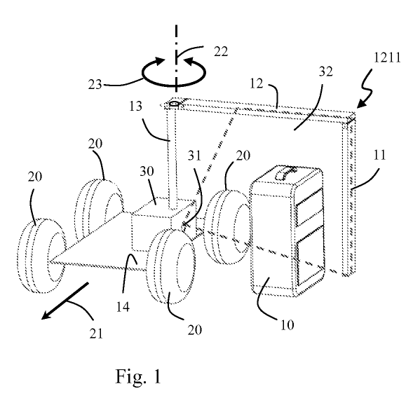

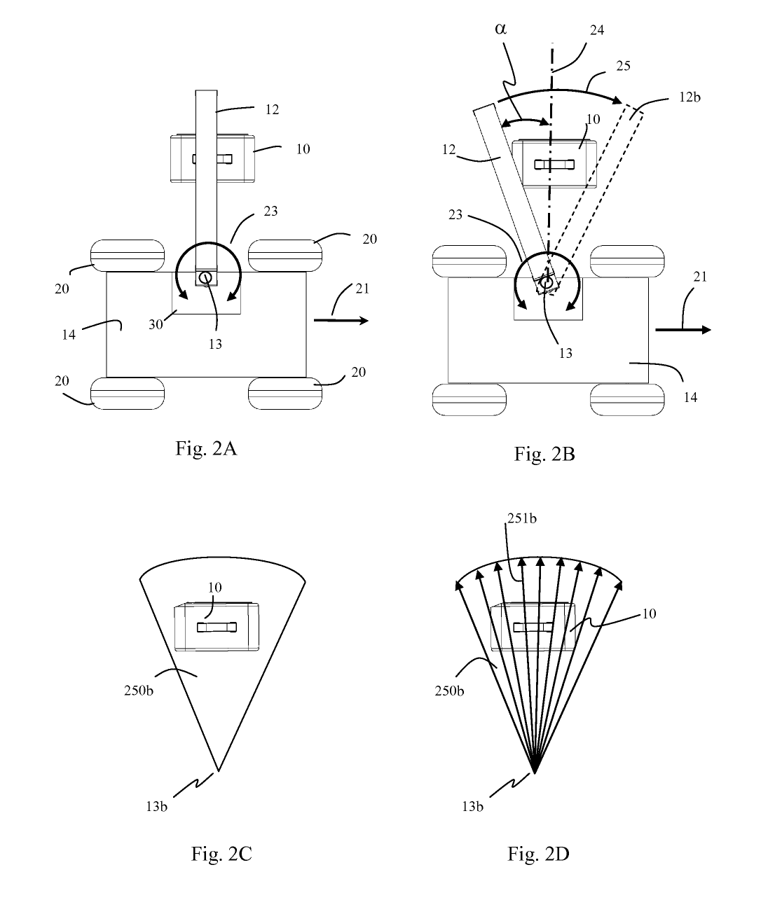

A simplified assembly of one or the first embodiment is shown in FIG. 1 and its top view is shown in FIG. 2A. A mobile platform 14 mounted on wheels 20 is shown. Mounted on the mobile platform 14 is an x-ray generator 30 with a source or focal point at 31 and emitting a radiation beam 32. A “L” shaped detector or detectors or detector assembly 1211 comprising of a horizontal detector arm 12 and vertical detector arm 11 is used to detect the radiation beam 32. A means to support detector 1211 at a predetermined distance from source 31 allows an object or a package 10 to be interposed between source 31 and detector 1211. Further, the means to support detector 1211 at a predetermined distance includes a vertical member 13 situated vertically above the source 31. A rotational means is used to swivel or rotate the detector assembly of 1211 around a vertical axis 22 or about the vertical member 13 as indicated by a circular arrow 23. This rotation provides a means to change the angle of incidence at which the radiation beam 32 intercepts the object 10.

It should be noted that since the detector arm 11 is connected to one end of detector arm 12 as shown in FIG. 1, rotating the detector arm 12 is the same as rotating the detectors or detector assembly 1211. Further, since the top view of FIG. 1 would show only the detector arm 12 and not the vertical detector arm 11, FIGS. 2-4 show only the detector arm 12. Therefore, whenever a reference is made to the angle or position or rotation of the detector arm 12, it should be understood that the reference also applies to the entire assembly of detectors 1211.

To scan a package or object 10, the mobile platform 14 is moved to a location that is next to or in the vicinity of the object 10 as shown in FIG. 1 and FIG. 2A. The mobile platform 14 is then kept stationary and the detector 12 or equivalently detectors 1211 are rotated as indicated by circular arrow 23. The distal end of detector 12, and hence the vertical detector arm 11 trace an arc as indicated by a circular arrow 25 shown in FIG. 2B. The half angle of rotation is shown in FIG. 2B as α, and the dotted line 24 shows the central position of the detector 12 which serves as a reference for the measure of angle α. At the start of the scan, the detector 12 is shown on one side of the object 10, and at the end of scan it has moved or rotated to a position indicated by 12b on the other side of object 10. By keeping the mobile platform stationary, there are no motion induced vibrations of the detectors 1211, this results in a high fidelity or high resolution image which is free from blurring which might have resulted otherwise due to motion over uneven terrain.

The rotation of detector 12 about vertical member 13 as seen from the top view of FIG. 2B, traverses a fan shaped or a pie shaped or sector shaped geometry 250b shown in FIG. 2C with the center of curvature or apex at 13b. This center of curvature 13b is coincident with the center of rotation of detector 12 about the vertical member 13 as apparent by looking at FIG. 2B. It is not necessary but to simplify the explanation, the center of curvature 13b is vertically above and collinear with the x-ray source 31 shown in FIG. 1. The radiation paths or ray paths from the x-ray source 31 to the detectors 1211 as seen from the top view of FIG. 2B, appear as radial lines 251b shown in FIG. 2D. As apparent to a person skilled in the art, FIG. 2D represents a fan beam shaped projection of the object 10 if a radiation source were placed at or below 13b. With reference to FIG. 2D, it is seen that the radiation paths or rays 251b strike the object 10 at different incidence angles. Therefore the rotational means to rotate the detector 1211 about 13 is effectively a means to change the angle of incidence at which the radiation path from source 31 to detector 1211 intercepts object 10.

It is well known to a person skilled in the art that a computing means is used to analyze the data collected or received or detected by detectors, hence no further details of computing means are being provided.

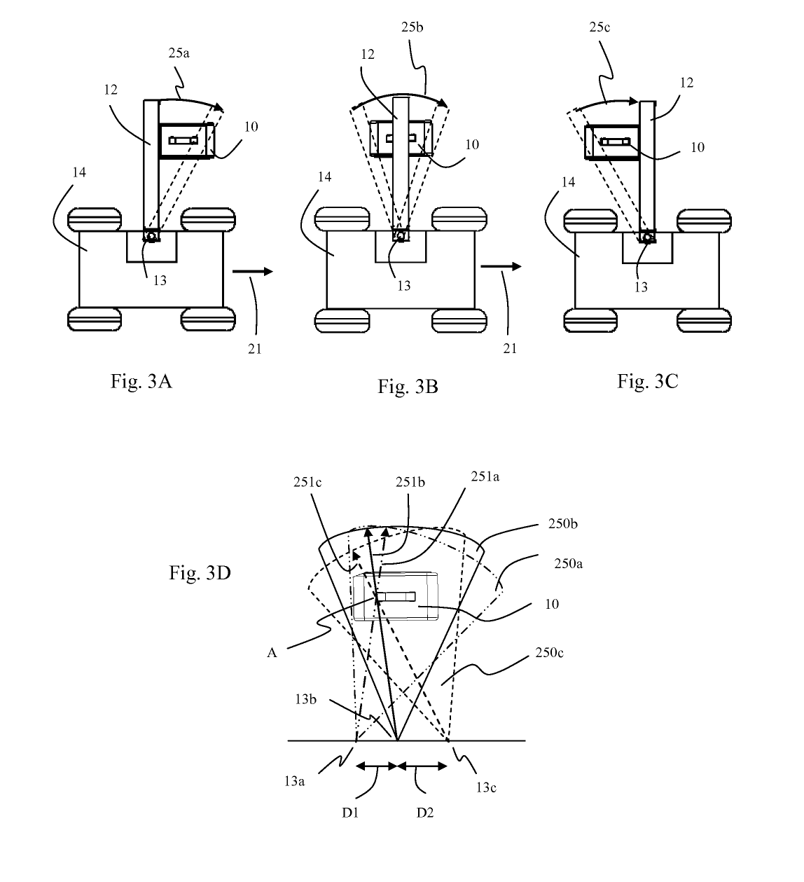

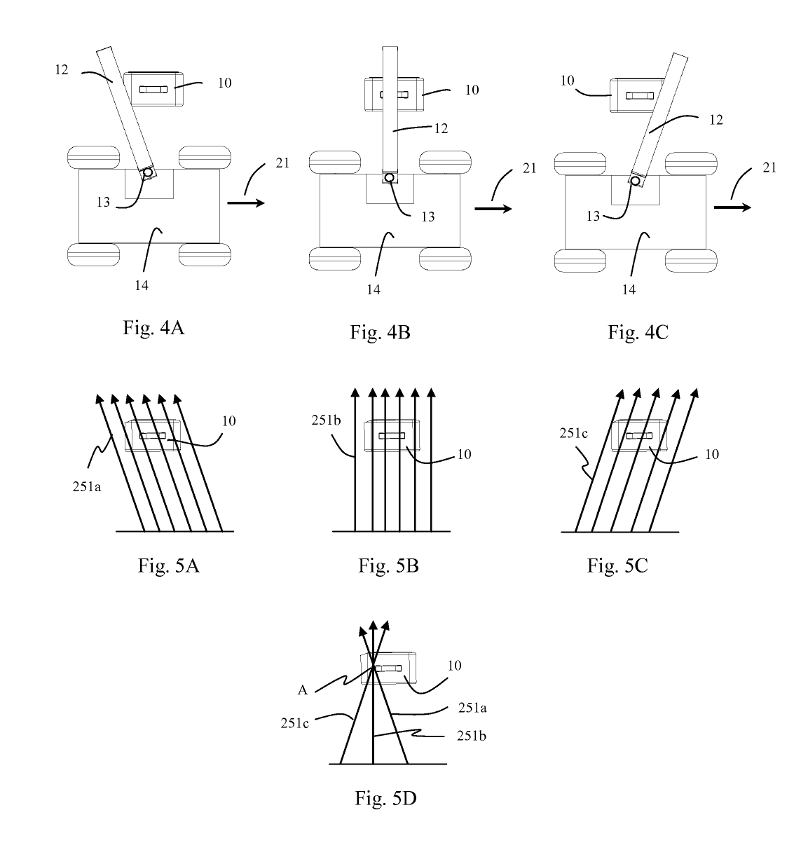

In order to further inspect the object 10 from different angles, multiview scanning is implemented as shown in FIGS. 3A to 3C. The first scan or view is obtained by positioning the mobile platform 14 such that the object 10 is to one side of the detector 12 as shown in FIG. 3A. In a manner similar to that explained with reference to FIG. 2B, the detector arm 12 is rotated about the vertical member 13 as indicated by an arc 25a in FIG. 3A.

To obtain a second view of object, the mobile platform is next moved in the direction of arrow 21 in FIG. 3A so that object is now positioned in the central position of the detector 12 as shown in FIG. 3B. In a manner as explained with reference to FIG. 2B, the detector arm 12 is now rotated about the vertical member 13 as indicated by an arc 25b in FIG. 3B.

To obtain a third view of object, the mobile platform is next moved in the direction of arrow 21 in FIG. 3B so that object is now positioned on the other side of the detector 12 as shown in FIG. 3C. In a manner as explained with reference to FIG. 2B, the detector arm 12 is now rotated about the vertical member 13 as indicated by an arc 25c in FIG. 3C.

The three scans obtained above can be analyzed to further examine the object 10. FIG. 3D shows one method employed to determine the 3D coordinates and the density reconstruction by the method of back projection of point A within the object 10. As explained with reference to FIG. 2C, the fan shaped scan or beam geometries for the scans of FIGS. 3A, 3B and 3C are shown in FIG. 3D as 250a, 250b and 250c respectively and their center of curvatures are shown as 13a, 13b and 13c respectively. In FIG. 3D, the distance D1 between 13a and 13b is the distance the mobile platform 14 is moved from its scan position of FIG. 3A to the scan position of FIG. 3B. Likewise, the distance D2 between 13b and 13c is the distance the platform 14 is moved from the scan position of FIG. 3B to the scan position of FIG. 3C. Arrows 251a, 251b and 251c are coincident at point A within the object 10 and are the respective radiation or ray paths for the scans of FIGS. 3A, 3B and 3C. As is well known to the person skilled in the art, the intersection of just any two of the rays 251a, 251b or 251c will suffice to determine the 3D coordinates of point A. Further, as is well known to a person skilled in the art, the density of point A can be approximated by just summing up the gray scale values of the scanned images corresponding to rays 251a, 251b and 251c. Repeating the above process for all points A within the object 10 thus reconstructs the 3D density of object 10.

In the above illustration, only three views or three scans were used to reconstruct point A within the object. However, only two or several more views can be used by repeatedly moving the platform 14 either in a straight line or to different locations around the object 10.

Another embodiment of the invention is illustrated in FIGS. 4A to 4C. Multiview scans are obtained for three different angular positions of the detector 12. The angular position of the detector 12 is defined by the angle of the detector with reference to the central position 24 shown in FIG. 2B. In the first scan, the detector arm 12 is rotated about the vertical member 13 so as to position it to one side of object 10 as shown in FIG. 4A. This position of the detector 12 is similar to that shown in FIG. 2B where the angle of the detector 12 to the central position 24 is denoted as α. The detector arm 12 is then kept fixed at this angle and the mobile platform 14 is moved in the direction of arrow 21 to scan the object 10, the corresponding ray paths 251a are shown in FIG. 5A. For the second view, the detector arm is rotated back to its central position as shown in FIG. 4B and now the angle α, which was explained with reference to FIG. 2B, is zero. The detector arm 12 is then kept fixed at this angle and the mobile platform 14 is moved in the direction of arrow 21 to scan the object 10, the corresponding ray paths 251b are shown in FIG. 5B. For the third view, the detector arm 12 is rotated about the vertical member 13 so as to position it to the other side of object 10 as shown in FIG. 4C and now the angle α, which was explained with reference to FIG. 2B, is negative. The angle of the detector arm 12 is then kept fixed while the platform 14 is moved in the direction of arrow 21 to scan the object 10, the corresponding ray paths 251c are shown in FIG. 5C.

It should be noted that the angle α for the three scans for FIGS. 4A-4C are predetermined before the start of the scans and held constant during the scans. It should be further noted that the angles at which the ray paths 251a in FIG. 5A, 251b in FIG. 5B, and 251c in FIG. 5C intercept the object 10 are also the angles of incidence at which the radiation beam 32 from source 31 to detector 1211 intercepts object 10.

As is well known to a person skilled in the art of laminography and tomographic image reconstructions, the density of a point A within object 10 can be approximated by the summation of the rays 251a, 251b and 251c shown in FIG. 5D. Again, as is well understood by the person skilled in art, by adjusting the delays between scans of FIGS. 5A, 5B and 5C and summing them, a 3D reconstruction of the entire volume of the object 10 can be realized.

In the above illustration, only three views were used, however, just two or several more views can be used by repeatedly scanning the object 10 with different angles of the detector arm 12 with reference to its central position, and by orienting the platform 14 at different angles to the object 10 for example by positioning the platform 14 at different locations around the object 10.

There are several embodiments possible as would be apparent to a person skilled in the art. For example, only the vertical detector arm 11 is used and the arm 12 would then be just a mechanical member without any detectors used only to support detector 11. In such a situation, the vertical member 13 and the horizontal arm 12 are then just a means to support the detector 11 at a predetermined distance from the source 31.

In another embodiment, the axis of rotation 22 for the detectors 1211 need not be directly above the focus 31 of the x-ray tube.

In another embodiment, the assembly of radiation source 30, vertical member 13, and detectors 12 and 11 need not be mounted on mobile platform 14, but just manually or by a robot placed on the ground next to the object 10 to be scanned. In another variation of this embodiment, there may not be any member 13 connecting the detector assembly 1211 to the x-ray generator 30. In such an embodiment, the detectors 11 and 12 could be translated linearly on the other side of object 10 by a suitable translational means to implement the scan of object 10.

In yet another embodiment, the radiation source 30 can be placed on the ground or floor under a desk for example with the radiation beam 32 pointing up. This configuration would be used to image a bag left on the desk. In such an embodiment, one detector arm 11 would be swept by a suitable means above the bag to be inspected.

In yet other alternative embodiments, the x-ray source 30 may be replaced by a radioactive source, or an electromagnetic source.

The foregoing description of the invention and its embodiments should be considered as illustrative only of the concept and principles of the invention. The invention may be configured in a variety of ways, shapes and sizes and is not limited to the description above. Numerous applications of the present invention will readily occur to those skilled in the art. Therefore, it is desired that the scope of the present invention not be limited by the description above but by the claims presented herein.

The invention claimed is:

1. A portable device suited for inspection of an object comprising of:
a radiation source emitting a radiation beam;
a radiation detector to detect said radiation beam;
a means to position said radiation detector at a predetermined distance from said radiation source so as to allow said object to be positioned between said radiation source and said radiation detector;
a means to change the position of said detector relative to said source so as to change the angle of incidence at which said radiation beam from said source to said detector intercepts said object; and
a computing means to analyze data from said detector.

2. The device of claim 1 further comprising of a means to move said detector and said source relative to said object.

3. A method for inspection of an object comprising of:
using a radiation source emitting a radiation beam;
using a radiation detector to detect said radiation beam;
positioning said source at a location in the vicinity of said object such that said radiation beam intercepts said object;
positioning said detector at a predetermined distance from said radiation source so as to allow said object to be positioned between said radiation source and said radiation detector;
using a means to change the position of said detector relative to said source so as to change the angle of incidence at which said radiation beam from said source to said detector intercepts said object;
collecting a set of data received by said detector; and
using a computing means to analyze said set of data.

4. The method of claim 3 further comprising the steps of:
moving said source to one or more additional locations in the vicinity of said object such that said radiation beam from each of said additional locations intercepts said object;
for each of said additional locations, positioning said detector at a predetermined distance from said radiation source so as to allow said object to be positioned between said radiation source and said radiation detector;
collecting a set of data received by said detector at each of said additional locations; and
using said computing means to analyze said set of data collected at each of said additional locations.

5. The method of claim 3 further comprising the steps of:
using said means to change the position of said detector relative to said source to set a predetermined angle of incidence at which said radiation beam from said source to said detector intercepts said object; and
translating said source and said detector relative to said object.

6. The method of claim 5 further comprising the steps of:
using said means to change the position of said detector relative to said source to set one or more additional predetermined angles of incidence at which said radiation beam from said source to said detector intercepts said object;
for each of said additional predetermined angles of incidence, translating said source and said detector relative to said object;
collecting at each of said additional predetermined angles of incidence a set of data using said detector; and
using said computing means to analyze said set of data collected at each of said additional predetermined angles of incidence.
